(19) United States
(12) Patent Application Publication
(10) Pub. No.: US 2006/0204615 A1
(43) Pub. Date: Sep. 14, 2006

(54) Process for foam control in brewery fermentations

(76) Inventor: Glen D. Austin, London (CA)

Correspondence Address: James W Kerr;Labatt Brewing Company Limited, 303 Richmond Street, London, ON, N6B 2H8, CA

(21) Appl. No.: 10/564,867

(22) PCT Filed: Jul. 13, 2004
(86) PCT No.: PCT/CA04/01027

§ 371 Date: Jan. 17, 2006

(30) Foreign Application Priority Data
Jul. 16, 2003 (CA) 2,435,422

(51) Int. Cl. C12C 11/00

(52) U.S. Cl. 426/16

(57) ABSTRACT

A method of controlling the foam generated during a beer wort fermentation is provided in which the pressure in the wort—containing tanks such as a fermentor is varied according to a cycle which allows the pressure to rise to a value preferably of less than about 14.9 psig when it is released until the foam bed stabilizes. The cycle is then repeated. The improved methods allow for less headspace in the vessel and greater efficiency in carbon dioxide collection.

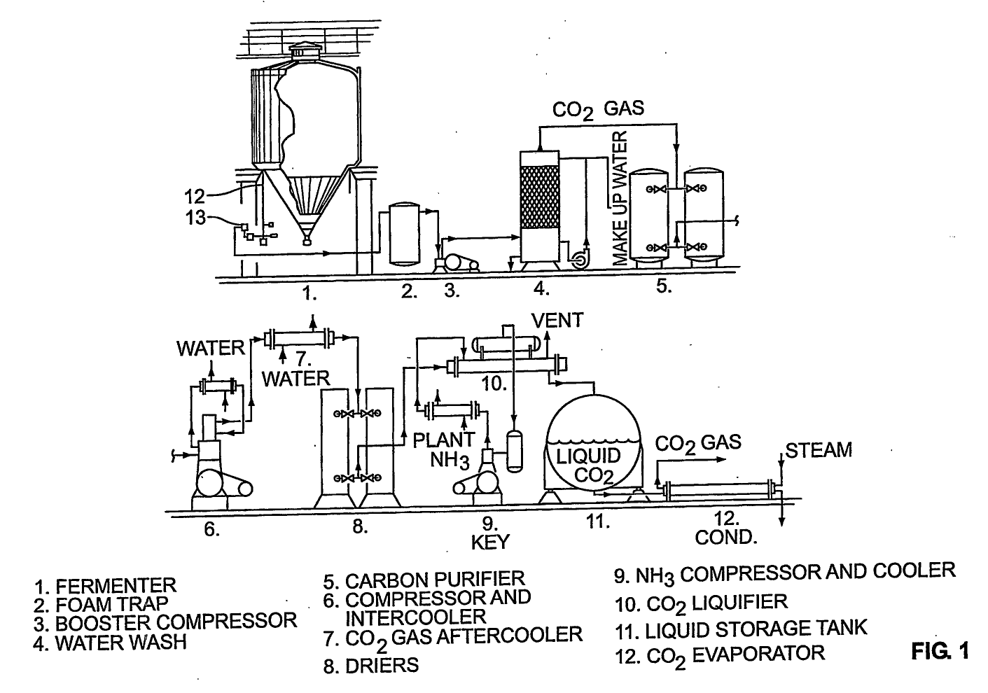

### FIELD OF THE INVENTION

The present invention relates to fermentation processes and in particular, such processes where wort is fermented to form a potable beverage such as beer and a foam is created during the fermentation.

### BACKGROUND OF THE INVENTION

The traditional fermentors and lagering tanks used in the brewing industry can only be constructed to a certain size. The drive for larger volumes and greater efficiencies led to the introduction of larger production units for the fermentation and maturation stages of beer production. This resulted in the introduction of the now familiar cylindroconical fermentation and lagering vessels (known as “CCV's”). These are closed vessels and because of the production of carbon dioxide during fermentation they are designed to handle a certain amount of pressure, in fact, to approximately 14.9 psig. However, fermentations are generally carried out at from about 0.5-1.5 psig.

The CCV's cannot, of course, be completely filled during fermentation because large volumes of foam are produced by carbon dioxide evolution and, in extreme cases, excess foam can exit the CCV via the various gas exit pipes and enter the pressure relief valves (PRV). This can be extremely dangerous since the wort in the escaping foam can block the action of the PRV and render them inoperable. The result can be a failure of the structure of the CCV which is clearly highly undesirable from safety and cost viewpoints.

This problem is addressed by leaving a volume, known as “headspace”, above the fermenting wort. Experience has shown that, for a regular beer, the fermentation tanks should have a headspace equal to at least 25% to 30% of the pitched wort volume. In some types of beer, e.g. a wheat beer fermentation, because of the greater foam generation, the headspace should be up to 40% of the pitched wort volume. This is quite significant commercially, for example, in a typical CCV having a wort volume of 969 hl. equivalent to 9.69 m², the headspace would be 24.2 m³, i.e. the total CCV volume is 121.1 m³. The total height of such a CCV is 11.15 m of which 1.75 meters is headspace (refer to Technology Brewing and Malting, International Edition, pp. 368 et seq.). It will be appreciated that leaving such a large headspace volume in reserve to deal with uncontrolled or excessive foam development greatly reduces the potential production capacity of the fermentor.

As is well known, the recovery of carbon dioxide produced during fermentation followed by purification, compression and liquidation for reuse in various processes in the brewery is now a valuable utility on a par with steam or water. This is especially so when fermentation and maturation occurs in a CCV where the carbon dioxide occurs in a concentrated form and can readily be lead away and collected (refer to example to pp. 393-394 of Technology Brewing and Malting). Collection is usually made in the period of maximum evolution following the initial period of venting when all air is being displaced to the final period when fermentation has slowed. Also, since the pressure in the fermentor is usually preferred to be low, about 0.5 to 1.5 psig, there is a booster compressor to increase the pressure of the carbon dioxide exiting the vessel about 3.5 to 5.0 psig to overcome pressure drops encountered in the water scrubber and carbon purifier prior to the collected gas reaching the compressor to be liquefied.

Subsequent to the fermentation, the beer is subjected to maturation which can also take place in sealed tanks such as CCV's. The young beer is transferred to the lager vessels in which continued fermentation can still be relatively vigorous. To avoid “frothing over” when solid particles and some extract can be lost, it is customary not to completely fill the lagering vessel initially but to top it up after a period when there is no longer any danger of loss of foam. Again, this is a control of foam issue but in the maturing rather than fermenting stage in the brewing process.

It is an objective of the present invention to provide a method of controlling the volume of foam generated during the production of beer and similar fermentations without the use of additives.

### SUMMARY OF THE INVENTION

It has now been found that the amount of foam produced during fermentation can be controlled and thereby significantly reduced by subjecting the fermenting wort to a repeating cycle of pressure increase followed by decrease. Specifically, the pressure engendered by the carbon dioxide gas produced by the fermentation is allowed to increase from a base value, preferably about that normally employed in such fermentations where the pressure is maintained at a relatively low value. The foam being produced increases in volume with gas evolution and thereby level in the vessel also increases while the pressure increases until it reaches a maximum which is significantly less than it would if the pressure was maintained at the constant level usual for that fermentation. As the pressure continues to increase the foam level volume commences to decline until it stabilizes at a reduced level. The pressure is then released, returning to a base level and the cycle is then repeated as desired.

It will be appreciated that, in addition to reducing the level of foam and thereby allowing a greater liquid content in the fermentor, the increased pressure has other effects these including:
1. Reduces production of some undesirable fermentation by-products such as esters and higher alcohols.
2. The pressure release produces an increased ascent of carbon dioxide bubbles in the wort thereby executing a gas wash effect. This can cause deabsorption and sweeping out of solution of some unwanted components such as hydrogen sulphide.

In one embodiment, the present invention provides a process of controlling foam production in a fermenting wort comprising repeating the following steps:

(i) Applying increasing pressure, preferably to a maximum of about 14.9 psig to said fermenting wort until foam volume reaches a maximum and then decays to a stabilized lower level;

(ii) Releasing said pressure; and

(iii) Repeating steps (i) and (ii) as desired.

In another embodiment, the present invention provides a process of controlling foam production in a fermenting wort comprising repeating a pressurizing cycle which includes the following steps:

(i) Allowing carbon dioxide gas generated during the fermentation to increase the pressure above the wort until it reaches a maximum of at most 14.9 psig and the amount of foam created has reached a maximum and then decays to a stabilized minimum; and

(ii) Releasing said pressure; and

(iii) Repeating steps (i) and (ii) as desired.

In another embodiment of the inventive process carbon dioxide gas generated during said fermentation is collected, scrubbed, filtered, dried and liquefied, and, preferable collection of the carbon dioxide commences approximately twenty hours following initiation of said fermentation.

As indicated, the process preferably utilizes a pressure of up to about 14.9 psig, preferably at most 10 psig and especially 4.6-7.5 psig.

In a further aspect the present invention provides a brewing process which utilizes a pressure cycle as described above in the primary fermentation and/or maturation stage involving a secondary fermentation.

### DESCRIPTION OF THE DRAWINGS

The present invention will be described but not limited by reference to the accompanying Figure and following Example.

The sole Figure is a generally diagrammatic of a fermentor and associated carbon dioxide collecting equipment used according to the present invention.

### EXAMPLE

An experimental fermentor having a capacity of nine (9) litres was fitted with a mercury pressure switch hooked up to a solenoid valve. The fermentor was charged with about six (6) litres of wort and a control fermentation at peak krausen and at a normal pressure for the system (about 0.5 psi) was run. The height attained by the foam was noted. Subsequently, with the pressure set at 1.5 psi, i.e. at the top end of a regular fermentation for the system, the fermentation was repeated. The foam attained a similar height to that of the control but, as the pressure rose to 1.5 psig, the height of foam decreased until it stabilized. At that point, the pressure was released and the foam bed returned to its original height, i.e. there was no reduction in foam.

The pressure was then raised to about 5 psig and the experiment was repeated. In this case, the amount of foam initially increased as before but, as the pressure increased, increase in the level of foam ceased, the level being less than that achieved in both earlier fermentations. The pressure was then released; significant breakage of bubbles in the foam bed was observed shortly after the depressurization, and the height of the foam bed decreased about 60% of its original maximum height. Subsequently, the height of the foam bed again increased with increasing pressure until the bed height approximately equaled the original maximum when it ceased growing and began reducing until stabilization when the pressure was again released.

Consequently using a pressure in excess of 1.5 psig in the fermentation stage of brewing, the headspace in the fermentor can be significantly reduced, by as much as about 50%. This, of course, allows more wort to be included in the fermentor thereby increasing the yield of beer with no increase in fermentor size.

Turning to the drawing this shows in generally diagrammatic form, a CCV operating as a fermentor and the associated equipment required to collect the carbon dioxide generated during the fermentation. In the drawing the numbers indicate the following:
1. Fermenter
2. Foam Trap
3. Booster Compressor
4. Water Wash
5. Carbon Purifier
6. Compressor and Intercooler
7. CO₂ Gas Aftercooler
8. Driers
9. NH₃ Compressor and Cooler
10. CO₂ Liquefier
11. Liquid Storage Tank
12. CO₂ Evaporator
13. Supply (carbon dioxide; air and CIP) to the dome installed in the insulation; and
14. Pressure cycle equipment of the invention and usual other pressure measuring and control equipment (safety valve, etc.)

It is believed that that basic operation of the system is well known—refer example to pages 350 et seq. of The Practical Brewer, Master Brewers Association of the Americas, 10^{th} Printing, 1993 which description is incorporated herein by reference. However, when the system operates according to the present invention, there is added further equipment, essentially a further pressure switch controlling a valve releasing the carbon dioxide to collection as well as controls to operate same in a cyclic and automatic manner.

One aspect of the operation should be noted however. The pressure cycle used according to the present intervention can involve pressures up to about 14 psig, preferably about 4-7.5 psig. Consequently, the fermentation is proceeding under an average pressure above normal (i.e. above 0.5-1.5 psig). Consequently, the average pressure of carbon dioxide exiting the fermentor is higher than normal which, as described herein, is an advantage of the present invention.

The system shown in FIG. includes a booster 3, required in prior art systems to raise the gas pressure to say 5 psig to overcome pressure drops encountered in the water scrubber and carbon purifier prior to the gas reaching the compressor. In the process of the present invention, use of booster 3 may be reduced or even possibly eliminated, with commensurate energy savings, because of the increased pressure of the gas leaving the fermentor.

The processes of the present invention have been specifically described with respect to the production of beer but may be used in any fermentation process where minimizing the amount of incidental foam produced would be advantageous.

1) A method of controlling foam production in a fermenting wort comprising repeating the following steps:
(i) Applying increasing pressure to said fermenting wort until foam volume reaches a maximum and then decays to a stabilized lower level;
(ii) Releasing said pressure; and
(iii) Repeating steps (i) and (ii) as desired.

2) A method of controlling foam production in a fermenting wort comprising repeating a pressurizing cycle which includes the following steps:
(i) Allowing carbon dioxide gas generated during the fermentation to increase the pressure above the wort until it reaches a maximum of at most 14.9 psig and the amount of foam created has reached a maximum and then decayed to a stabilized minimum; and
(ii) Releasing said pressure; and
(iii) Repeating steps (i) and (ii) as desired.

3) A process according to claim 1 or 2 wherein said pressure is at most 14.9 psig.

4) A process according to claim 1 or 2 wherein said pressure is at most 10 psig.

5) A process according to claim 1 or 2 wherein said pressure is from about 4.6 to 7.5 psig.

6) A process according to claim 2 wherein carbon dioxide gas generated during said fermentation is collected, scrubbed, filtered, dried and liquefied.

7) A process according to claim 6 wherein the collection of the carbon dioxide commences approximately twenty hours following initiation of said fermentation.

8) A process according to claim 1 or 2 in which said fermentation is a primary fermentation.
